(19) United States
(12) Patent Application Publication
(10) Pub. No.: US 2008/0106492 A1
(43) Pub. Date: May 8, 2008

(54) Display device with light emitting diode

(75) Inventor: Sheng-Wei Chen, Chung Ho City (TW)

Correspondence Address: RABIN & Berdo, PC, 1101 14TH STREET, NW, SUITE 500, WASHINGTON, DC, 20005, US

(73) Assignee: AmTRAN TECHNOLOGY CO., LTD, Taipei (TW)

(21) Appl. No.: 11/709,241

(22) Filed: Feb. 22, 2007

(30) Foreign Application Priority Data
Nov. 8, 2006 (TW) 095219740

(51) Int. Cl. G09G 3/14

(52) U.S. Cl. 345/39

(57) ABSTRACT

A display device with light emitting diode (LED) is provided. The display device includes an outer frame, a signal switching circuit for receiving/detecting/analyzing an input signal and outputting a corresponding signal, and an LED control circuit for receiving the corresponding signal output from the signal switching circuit and outputting a control signal. The LED control circuit at least includes a pulse width modulation (PWM) circuit for sending a pulse signal to adjust the control signal. Moreover, the display device includes at least an LED, and luminance and tone of light emitted by the LED is controlled with the control signal received.

### CROSS-REFERENCE TO RELATED APPLICATIONS

This non-provisional application claims priority under 35 U.S.C. §119(a) on Patent Application No(s). 095219740 filed in Taiwan, R.O.C. on Nov. 8, 2006, the entire contents of which are hereby incorporated by reference

### BACKGROUND OF THE INVENTION

1. Field of Invention

The present invention relates to a display device, and more particularly to a display device with light emitting diode (LED).

2. Related Art

In recent years, with the development of science and multimedia technology, electronic products provide many convenient functions. Meanwhile, the requirements on the functions, visual effects, and value perceptions of the multimedia electronic devices are increasing continuously. Therefore, on the current market, in addition to the fine quality and powerful functions of the products, the feeling of the consumers when the products are used and the convenience and comfort brought about by the products also cannot be ignored. If a product is designed to be variable and modern in use to enhance the fun and comfort of the user, the competitiveness of the product can be improved on the market.

As a modern people often has to face a computer display device for a long time to deal with a lot of work, and the average time on computer keeps increasing, in recent years, the mainstream of display devices is liquid display (LCD) devices, which have taken place of the conventional cathode ray tube (CRT) displays. The LCD devices are thin, light, and convenient to carry, and more importantly, the radiation of the LCD devices is low. Therefore, they are more comfortable and healthier to the user.

However, if the display device that is used for a long time by the user every day is more variable and modern, the user will be more comfortable, and the pressure in working can be relieved, which helps to improve the working efficiency of the user.

In the conventional art, the outer frame of a general LCD device only provides the functions of protection and support, and is invariable. Therefore, after the computer is started, the user cannot feel a human-centered design while facing much work and documents to be handled. When the computer is used to play music, the user can only listen to the music with ears. Thus, only the ears of the user are entertained, while the visual pleasure is sacrificed as the user has to face the documents visually. In the conventional art, the parameter adjusting functions of an LCD device only include the brightness adjustment, contrast adjustment, image position adjustment, and color adjustment, but cannot provide color settings or situational designs according to personal requirements, feelings or tastes.

Therefore, a design of an LCD device that better satisfies the requirements of a user and provides comfort and variability in use must be provided.

### SUMMARY OF THE INVENTION

In view of the above problem, the object of the present invention is to provide a peripheral outer frame design of an LCD device, which has a variable LED light emitting effect, so as to solve the problem in the conventional art that the outer frame of the LCD device is not variable, and the user does not feel comfort, variability, and human-centered design when the display device is operated.

To achieve the aforementioned object, the present invention discloses a display device with LED. The display device with light emitting diode includes an outer frame; a signal switching circuit for receiving an input signal, detecting and analyzing the input signal and outputting a corresponding signal; a LED control circuit for receiving the corresponding signal output from the signal switching circuit and outputting a control signal, wherein the LED control circuit at least includes a pulse width modulation (PWM) circuit for sending a pulse signal to adjust the control signal; and at least an LED disposed on the outer frame, wherein luminance and tone of light emitted by the LED is controlled with the received control signal output from the LED control circuit.

The effect of the present invention is realized through the above design. Thus, a user operarting the LCD device for a long time can use parameter setting buttons to adjust luminance and tone of light emitted by the LED according to personal tastes, so as to establish a favorite situational design. Moreover, when listening to music, the atmosphere of the music and visual feelings can be enhanced through synchronous visual changes. More sense organs are stimulated and influenced by the music, so the user can enjoy the music better. In addition, the light emitting effect of the LED on the LCD enables the user to feel the variability and human-centered design. Thus, the fun of working is improved, and the working efficiency is increased accordingly.

The description on the content of the present invention above and the description on the embodiments below are used to exemplify and explain the principle of the present invention, and provide further explanation on the claims of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1A is a schematic view of a display device with LED;

FIG. 1B is a system block diagram of a display device with LED;

FIG. 2 is a system block diagram of a first embodiment according to the present invention;

FIG. 3 is a system block diagram of a second embodiment according to the present invention;

FIG. 4A is a schematic view of a third embodiment according to the present invention;

FIG. 4B is a system block diagram of the third embodiment according to the present invention; and

FIG. 5 is a schematic view of the LCD device of a fourth embodiment according to the present invention.

### DETAILED DESCRIPTION OF THE INVENTION

To make the object, structure, features and function of the present invention more comprehensible, the present invention is illustrated below in detail with embodiments.

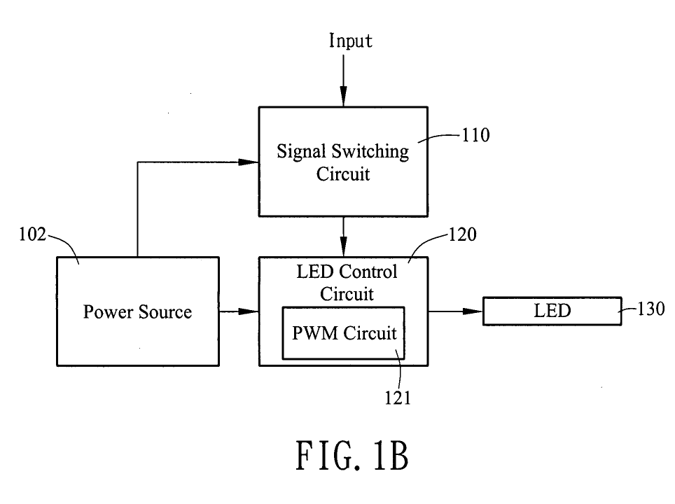

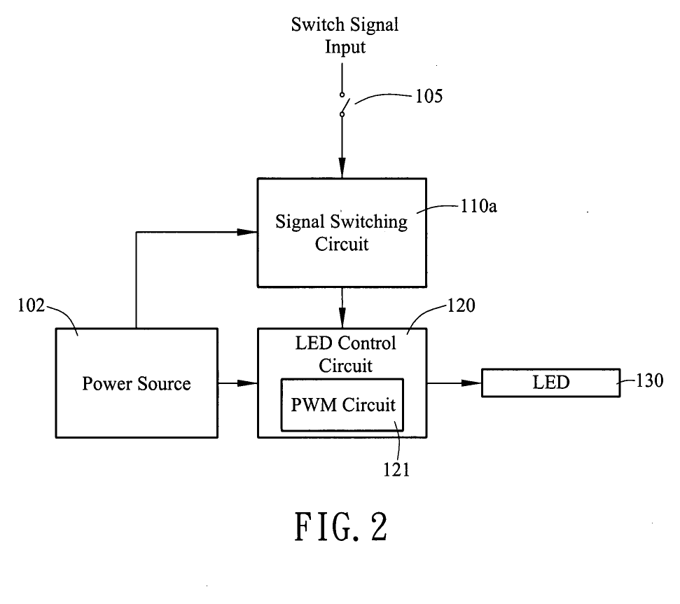

FIGS. 1A and 1B are a schematic view and a system block diagram of a display device with LED respectively. First, referring to FIGS. 1A and 1B, the display device with LED according to the present invention includes a display device body 100, a power source 102, a signal switching circuit 110, and a LED control circuit 120. The display device body 100 includes an outer frame 101, and at least a LED 130 is disposed on the outer frame 101. The LED control circuit 120 includes at least a pulse width modulation (PWM) circuit 121, and the power source 102 at least provides working currents required by the signal switching circuit 110, the LED control circuit 120, and the LED 130. The LED 130 is a LED with variable luminance, and the working voltage thereof is 0 to 5 Volt. For different voltages and currents, the LED 130 will have different luminance.

When an input signal is input to the signal switching circuit 110, the signal switching circuit 110 must be configured correspondingly for different input signals. A plurality of different signal switching circuits 110 corresponding to different embodiments will be illustrated. When the corresponding signal switching circuit 110 receives an input signal, the input signal is detected and analyzed, and a corresponding signal is output and transmitted to the LED control circuit 120. The main function of the LED control circuit 120 is adjusting and controlling the LED 130 to generate the luminance and tone according to the corresponding signal.

The LED control circuit 120 receives the corresponding signal transmitted from the signal switching circuit 110, and adjusts the signal with the PWM circuit 121 therein. The main adjusting method of the PWM circuit 121 is that a transistor (not shown) is connected and functions as a switch, and the PWM circuit 121 is connected to the LED 130 via the transistor. When the LED 130 needs higher luminance and more light quantity, a high level pulse signal is transmitted to the transistor through the PWM circuit 121. As the duty ratio of the pulse signal becomes longer, when the transistor receives the high level pulse signal, the transistor is turned on, and the time that the transistor is ON also becomes longer. Therefore, the LED 130 emits more light and has higher luminance. On the contrary, when the PWM circuit 121 transmits a low level pulse signal to the transistor, the transistor is turned off, and the LED 130 is turned off as well. However, when the present invention includes a plurality of LEDs 130 with different tones, the LEDs 130 are connected to corresponding transistors and the PWM circuits 121. The PWM circuits 121 for adjusting the LEDs 130 of different tones transmit pulse signals of specific duty ratios to corresponding circuits. Thus, the light emitting time and luminance of the plurality of LEDs 130 of different tones can be adjusted with the PWM circuits 121 individually. Therefore, the pulse signals output by the PWM circuit 121 can adjust the control signals output to the LEDs 130 from the LED control circuit 120, such that the light emitted by the LEDs 130 can be adjusted to different and variable tones. In addition, the LED control circuit 120 can further include a variable current circuit (not shown), which provides a current to the LEDs 130. The current can be modulated according to the corresponding signal, such that the LEDs have different luminance according to different working currents.

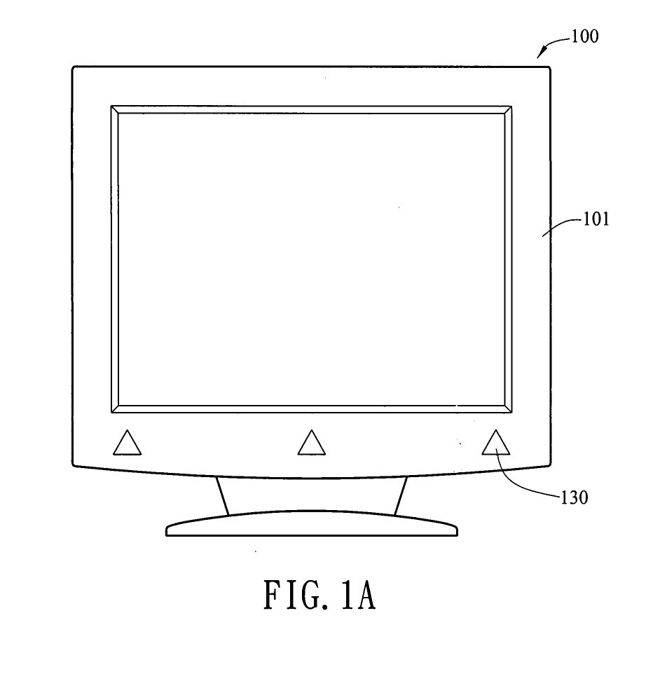

FIG. 2 is a system block diagram of a first embodiment according to the present invention. Referring to FIG. 2, a switch element 105 is further provided in this embodiment. When the switch element 105 is turned on, a power source ON/OFF signal is transmitted to the signal switching circuit 110a, and is analyzed and detected by the signal switching circuit 110a. When it is determined that the received signal is a power source ON signal, a corresponding signal is transmitted to the LED control circuit 120.

In this embodiment, when the power source needs to be turned on, the light emitting effect of the LED 130 is that the luminance gradually becomes higher and lower, such that the outer frame 101 of the LCD device is variable and modern. The light emitting effect of the display device changes as the breath of people, which performs more friendly to the users. Therefore, the PWM circuit 121 and the variable current circuit of the LED control circuit 120 modulate the received corresponding signal as follows. The PWM circuit 121 sends a periodical pulse signal, such as a sine pulse, a cosine pulse, and a triangular pulse. The variable current circuit sends out the working current with slow but continuous changes. Thus, the effect of simulating the breath with the luminance gradually becoming higher and lower is achieved, which provides a human-centered feeling.

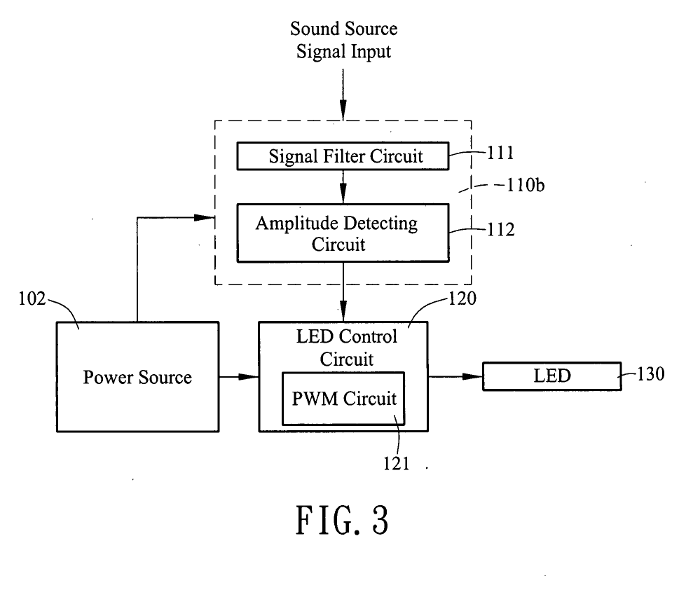

FIG. 3 is a system block diagram of a second embodiment according to the present invention. Referring to FIG. 3, the main difference between the second embodiment and the first embodiment of the present invention is that the function of the signal switching circuit is changed. The signal switching circuit 110b of the second embodiment includes a signal filter circuit 111 and an amplitude detecting circuit 112. When an input signal is a sound source signal, the sound source signal passes through the signal filter circuit 111 first, where the noise in the input sound source signal or generated during the transmission of the sound source signal in the circuit is filtered. The sound source signal without the noise is then transmitted to the amplitude detecting circuit 112, where the amplitude distribution of the sound source signal is detected and analyzed, and a corresponding signal corresponding to the amplitude change of the sound source signal is sent to the LED control circuit 120.

In this embodiment, it is desired that the light emitting effect of the LED 130 is related to the amplitude of the sound source signal, i.e., when the amplitude of the sound source signal is greater, the luminance of the LED 130 is higher; on the contrary, when the amplitude of the sound source signal is smaller, the luminance of the LED 130 is lower. Therefore, the LED control circuit 120 has to receive a corresponding signal according to the amplitude. When the sound source signal has great amplitudes, the PWM circuit 121 in the LED control circuit 120 sends a high level pulse signal to the transistor, such that the transistor is turned on, and the LED 130 emits more light. In addition, the variable current circuit also outputs a greater working current to the LED 130, such that the LED 130 has higher luminance. On the contrary, when the sound source signal has small amplitudes, the PWM circuit 121 in the LED control circuit 120 sends a low level pulse signal to the transistor, such that the transistor is turned off, and the LED 130 emits less light. In addition, the variable current circuit also outputs a smaller working current to the LED 130, such that the LED 130 has lower luminance. Therefore, this embodiment realizes the function that the luminance of the LED 130 changes according to the volume (amplitude) of the sound source signal with the operation of the above two circuits. Thus, when listening to music in front of the LCD device, the user can not only enjoy the music, but also has the visual entertainment as the luminance of the LED 130 changes with the music, which enhances the comfort when listening to music. The first and second embodiments of the present invention is not limited to including only one LED 130 disposed on the outer frame 101 of the display device body 100, but can include a plurality of LEDs 130 disposed on the outer frame 101 of the display device body 100. In addition, it is not limited in this embodiment that the luminance of the LED 130 is related to the amplitude of the sound source signal. Instead, the amplitude of the sound source signal can be designed to be related to the tone of the LED 130 as well.

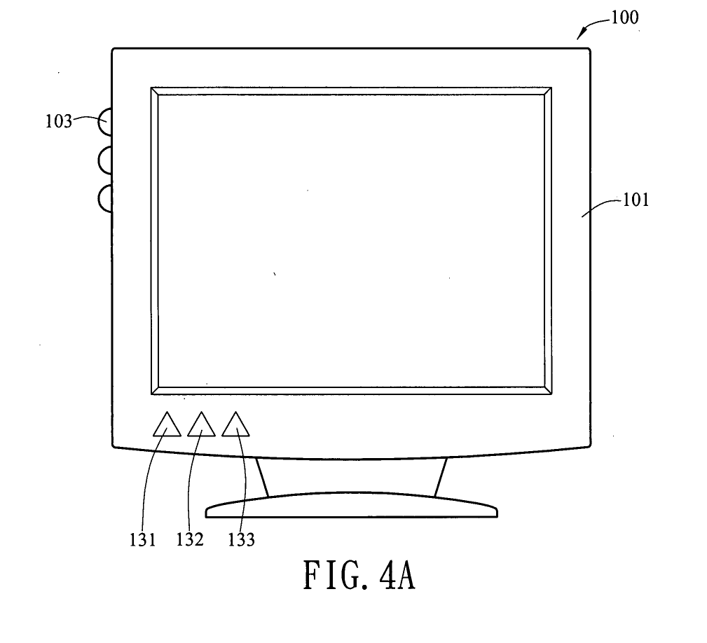

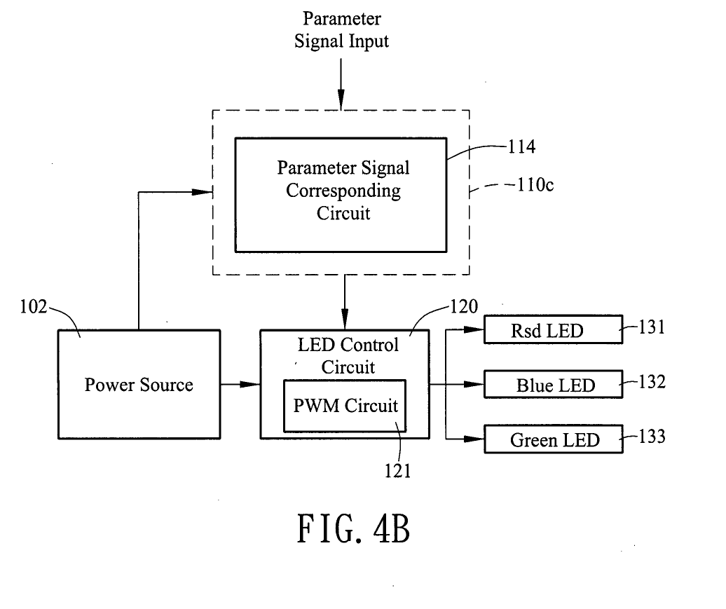

FIGS. 4A and 4B are a schematic view and a system block diagram of a third embodiment according to the present invention respectively. Referring to FIGS. 4A and 4B, the greatest difference between the third embodiment and the above embodiments of the present invention is also that the function of the signal switching circuit is changed. This embodiment also uses a plurality of LEDs emitting light of different wavelengths, including a red LED 131, a blue LED 132, and a green LED 133. Generally, a plurality of parameter setting buttons 103 is disposed on the display device body 100, so as to adjust various settings of the LCD device, such as brightness, contrast, image shift, and color, according to personal requirements and tastes of the user. However, with the use of the present invention, the variability of the display device body 100 will be improved, which better satisfies the requirements of the user. The signal switching circuit 110c of the third embodiment includes a parameter signal corresponding circuit 114. When the user presses a parameter setting buttons 103 according to personal requirements to adjust the parameter, the parameter signal is transmitted to the parameter signal corresponding circuit, and the value of the parameter signal is detected and analyzed. Then, a preset corresponding signal corresponding to the value of the parameter signal according to the type and value of the parameter signal is transmitted to the LED control circuit 120, so as to adjust the LED 130 according to the of the user's requirements and tastes.

In this embodiment, it is desired that the light emitting effect of the LED is presented in different situational modes according to different parameter settings, and can be set according to the tastes of the user. Therefore, when the LED control circuit 120 receives different corresponding signals generated according to different parameter signal values from the signal switching circuit 110c, such that the PWM circuit 121 and the variable current circuit, corresponding to the different corresponding signals, generate different pulse signals and working currents. For example, when the user adjusts the parameter settings of the luminance of the display device body 100, so as to make the luminance of the display device body 100 lower, the user can preset the parameter adjustment to representing a dark situational design expected by the user, i.e., the expected images being in a series of colors such as dark and purple. Therefore, when the parameter signal is input to the parameter signal corresponding circuit 114, a preset corresponding signal is output to the LED control circuit 120. The corresponding signal is transmitted to the PWM circuits 121 of the LED control circuit 120, and the PWM circuits 121 corresponding to the red LED 131 and the blue LED 132 respectively generate a high level pulse and send the pulse to the transistors connected with the LEDs at the same time, such that the transistors are turned on, and the red LED 131 and the blue LED 132 emit light individually. On the contrary, the PWM circuit 121 corresponding to the green LED 133 generates a low level pulse signal and sends the signal to the transistor connected with the green LED 133, such that the transistor is turned off. Therefore, the lights emitted by the plurality of LED light sources are blended to form a purple light. Meanwhile, the corresponding signal is transmitted to the variable current circuit, and the variable current circuits corresponding to the red LED 131 and the blue LED 132 outputs smaller working currents, such that lower luminance is output to generate the light emitting effect of the color of dark purple. Thus, the favorite setting mode of the user is achieved. However, the present invention is not limited to the above situational mode setting. Any design that uses parameter settings to adjust the light emitting effect of LEDs shall fall into the scope of protection of the present invention.

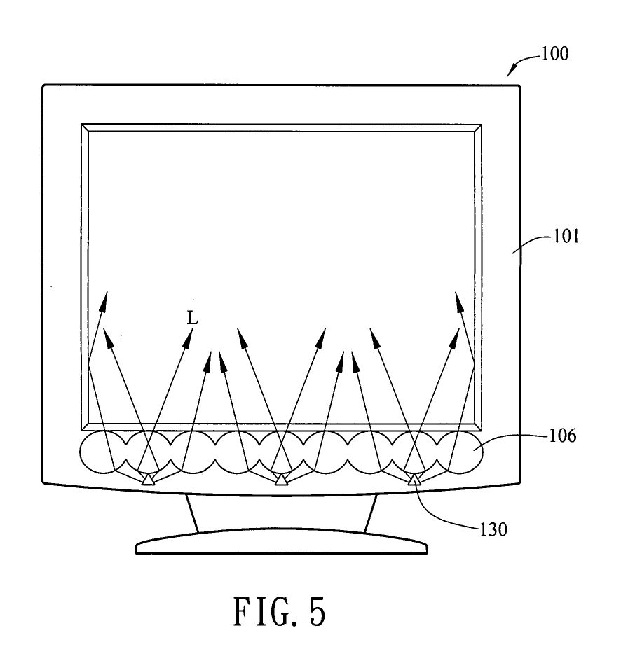

FIG. 5 is a schematic view of the LCD device of a fourth embodiment according to the present invention. The outer frame design of the LCD device of the present invention not only uses a normal plastic material which provides the functions of protection and support, moreover, as shown in FIG. 5, a plurality of cylindrical lenses 106 can be disposed on the outer frame 101 of the display device body 100. When the light emitting effect of the LEDs 130 is adjusted with the LED control circuit 120 according to the first, second and third embodiments of the present invention, the luminance and tone of the LEDs 130 can be modulated, but the light emitting effect is still limited to an effect that the LEDs 130 are used as point light sources. However, if the cylindrical lenses 106 are disposed in front of the LEDs 130, the light L emitted by the LEDs 130 will be refracted by the cylindrical lenses 106, and then be incident on the LCD panel. Thus, the light emitting effect other than that of point light sources is achieved, as the cylindrical lenses 106 transmit the light L emitted by the LEDs 130 to the entire plane of the LCD panel. Therefore, the desired light emitting effect of the LEDs 130 adjusted by the LED control circuit 120 is presented more extensively.

According to the design of the present invention, a user operating the LCD device for a long time can use parameter setting buttons to adjust the luminance and tone of light emitted by the LED according to personal tastes, so as to establish a favorite situational design. Moreover, when one listens to music, the entertainment to the user is enhanced through synchronous visual changes. In addition, the light emitting effect of the LED on the LCD enables the user to feel the variability and human-centered design. Thus, the fun of working is improved, and the working efficiency is increased accordingly as well.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A display device with light emitting diode (LED), comprising:
an outer frame;
a signal switching circuit, for receiving an input signal, detecting and analyzing the input signal, and outputting a corresponding signal;
an LED control circuit, for receiving the corresponding signal output from the signal switching circuit, and outputting a control signal, wherein the LED control circuit at least comprises a pulse width modulation (PWM) circuit for sending a pulse signal to adjust the control signal; and
at least an LED disposed in the outer frame, wherein luminance and tone of light emitted by the LED is controlled with the received control signal output from the LED control circuit.

2. The display device with LED as claimed in claim 1, further comprising a power source for providing working currents required by the signal switching circuit, the LED control circuit, and the LED.

3. The display device with LED as claimed in claim 1, wherein the LED control circuit further comprises a variable current control circuit for modulating a current value output by the control signal.

4. The display device with LED as claimed in claim 1, wherein the input signal is a sound source signal, and the signal switching circuit comprises at least an amplitude detecting circuit for detecting amplitude variation of the sound source signal, and outputting the corresponding signal according to the amplitude variation.

5. The display device with LED as claimed in claim 4, wherein the signal switching circuit further comprises a signal filter circuit connected to a front terminal of the amplitude detecting circuit, for filtering noise in the sound source signal.

6. The display device with LED as claimed in claim 1, wherein the input signal is at least a parameter signal of a plurality of parameter setting buttons of the LCD device, and the signal switching circuit comprises a parameter signal corresponding circuit, and outputs a corresponding signal according to the parameter signal.

7. The display device with LED as claimed in claim 1, wherein the input signal is a power source ON/OFF signal, and the signal switching circuit detects the power source ON/OFF signal, and outputs the corresponding signal.

8. The display device with LED as claimed in claim 7, wherein the power source ON/OFF signal is controlled by a switch element.

9. A display device with light emitting diode (LED), comprising:
an outer frame, wherein at least a cylindrical lens is disposed on at least a side of the outer frame;
a signal switching circuit, for receiving an input signal, detecting and analyzing the input signal, and outputting a corresponding signal;
an LED control circuit, for receiving the corresponding signal output from the signal switching circuit, and outputting a control signal, wherein the LED control circuit at least comprises a pulse width modulation (PWM) circuit for sending a pulse signal to adjust the control signal; and
at least an LED disposed outside the cylindrical lens, wherein luminance and tone of light emitted by the LED is controlled with the received control signal output from the LED control circuit.

10. The display device with LED as claimed in claim 9, further comprising a power source for providing working currents required by the signal switching circuit, the LED control circuit, and the LED.

11. The display device with LED as claimed in claim 9, wherein the LED control circuit further comprises a variable current control circuit for modulating a current value output by the control signal.

12. The display device with LED as claimed in claim 9, wherein the input signal is a sound source signal, and the signal switching circuit comprises at least an amplitude detecting circuit for detecting amplitude variation of the sound source signal, and outputting the corresponding signal according to the amplitude variation.

13. The display device with LED as claimed in claim 12, wherein the signal switching circuit further comprises a signal filter circuit connected to a front terminal of the amplitude detecting circuit, for filtering noise in the sound source signal.

14. The display device with LED as claimed in claim 9, wherein the input signal is at least a parameter signal of a plurality of parameter setting buttons of the LCD device, and the signal switching circuit comprises a parameter signal corresponding circuit, and outputs a corresponding signal according to the parameter signal.

15. The display device with LED as claimed in claim 9, wherein the input signal is a power source ON/OFF signal, and the signal switching circuit detects the power source ON/OFF signal, and outputs the corresponding signal.

16. The display device with LED as claimed in claim 15, wherein the power source ON/OFF signal is controlled by a switch element.
